(19) United States
(12) Patent Application Publication
(10) Pub. No.: US 2015/0010375 A1
(43) Pub. Date: Jan. 8, 2015

(54) SELF-TAPPING SCREW

(71) Applicant: RUIA GLOBAL FASTENERS AG, Neuss (DE)

(72) Inventors: Thorsten Schraer, Gerolsbach (DE); Peter Egger, Baar (CH)

(21) Appl. No.: 14/375,971

(22) PCT Filed: Jan. 31, 2013
(86) PCT No.: PCT/DE2013/200003

§ 371 Date: Jul. 31, 2014

(30) Foreign Application Priority Data
Feb. 23, 2012 (DE) 20 2012 001 847.7

(51) Int. Cl. F16B 25/00

(52) U.S. Cl. CPC F16B 25/0073; F16B 25/00
USPC 411/414

(57) ABSTRACT

A self-tapping screw having a head and an outer thread carrier with an end at which the outer thread has an outer diameter decreasing towards the end, at least over a part of the length thereof ending at the end, and the outer diameter of the outer thread decreases according to the draft angle of holes in which the screw is to be set.

### TECHNICAL FIELD

The present invention relates to a self-forming screw which is suitable specifically for use in untreated moulded holes with a corresponding draft angle.

### PRIOR ART

Self-tapping screws which are commercially available for example under the trade name “TAPTITE®” are proving to be increasingly popular commercially, because they can offer a considerable savings potential compared to conventional screw connections with preformed or pre-cut female threads. Overall, the great financial advantage is seen in the fact that it is possible to avoid the machining of the pre-moulded hole as well as the subsequent thread-forming and thread-cutting procedures. For uses in moulded parts, the self-tapping screws are screwed directly into the conically moulded hole (the conicity is produced due to the draft angle demanded by the moulding process).

Due to the cylindrical shape of the screw and to the shape of the moulded hole which is necessarily always conical on account of the draft angle, an optimum flank engagement is never obtained. In the case of very great screw-in depths, the engagement in the upper region can even approach zero.

It is therefore the object of the present invention to provide a self-tapping screw which has as far as possible an optimum flank engagement even in conically moulded holes and to generally increase the pull-out strength of self-tapping screws in conically moulded holes.

In the prior art, only the best possible compromise could ever be attempted when self-tapping screws were screwed into moulded holes. The lower region of the hole was configured for a maximum engagement and the upper region was configured for the engagement produced by the conicity. The screw-in depths then had to be selected such that in the upper region, there was still a technically reasonable engagement and not as deep as would have actually been necessary to transmit the forces into soft materials like a moulding. Therefore, hitherto it has only been possible to achieve suitably sized screw-in depths for metric standard connections with cylindrically prefabricated or at least cylindrically pre-drilled screw-in holes.

In recent years, more problems have arisen, since self-tapping screws were previously only used for minor connections. Due to cost pressures in the current market, structural connections are increasing, for which self-tapping screws are also to be screwed beyond the elastic limit, subsequently arriving at the limits of transferrable pull-out strength.

Thus, hitherto it has only been possible to reach the best possible compromise. According to the prior art, attempts have also been made to provide the smallest possible draft angles, which then presents problems again in the moulding process during removal from the mould. Furthermore, in the prior art, in some cases engagements of more than 100% were provided which could sometimes be implemented in soft material with good lubrication. However, the prior art has not been able to provide a real solution to this problem.

### PRESENTATION OF THE INVENTION

This object is achieved according to the invention by a self-tapping screw which is not cylindrical at least over part of its screw-in depth, but has a conicity corresponding to the conicity of the moulded hole.

Since almost all configurations of self-tapping screws have to be configured and tested beforehand from a practical point of view—tailoring of the conical moulded hole, tailoring of the screw-in depth, adjustment of the lubrication of the screw etc., i.e. they all have to be individually adjusted, an individual adaptation of the screw shape to a specific application is sensible and possible.

In addition, in the case of moulded holes, fixed angles of approximately 1.2° have become established anyway for the draft angle, so that for most uses, the conicity of the screws can be set at 1.2°.

If the screw is as conical as the hole, a consistent flank engagement can be achieved over the entire screw-in length for a specific screw-in depth, to be previously determined, as is otherwise only possible in the case of cylindrical or cylindrically pre-drilled holes.

To facilitate the screwing in of the conical screws, it is particularly preferred for the flanks of the thread pitches to be narrower or slimmer with an increasing diameter compared to the thread pitch in the region of the front end of the screws. For example, for each flank it is possible to reduce the flank angle by 0.5° or to reduce the foot width between the flanks of the thread pitch by 1% to cornpensate for the forming work, required due to the conicity, and for the resulting greater screw-in torque.

Furthermore, in order to implement an even greater engagement depth and thereby to increase the proportion of supporting nut material, it is preferred to apply additional small prominences to the flank tips. If appropriate, this is in connection with the narrowing or slimming of the flanks with an increasing external diameter of the outer thread.

In particular, the object of the present invention is achieved by a self-tapping screw having a head and an outer thread carrier with an end, the outer thread of the carrier having an external diameter which decreases towards the end at least over a part of its length adjoining the end.

In this respect, it is preferred if the external diameter of the outer thread decreases according to the draft angle of the holes into which the screw is to be inserted. This allows an optimum flank engagement.

In order not to have to construct an individual screw for each use, it is preferred that the external diameter of the outer thread decreases such that a line, which joins the tips of the pitches of the outer thread, runs towards the end at an angle of 1.0 to 1.5 angular degrees, preferably at 1.2 angular degrees towards the rotational axis of the outer thread. In respect of the conventional draft angle of 1.2° for moulded holes, it is consequently possible to implement a flank engagement which is still almost optimum for most cases of use, without special screws having to be used in each case.

It is also preferred if the region of a decreasing external diameter extends over approximately half of the outer thread.

To keep the screw-in torque as low as possible during tapping, it is preferred if the spacing of the flanks of the thread pitch decreases from the end of the screw to the head of the screw.

In this respect, it is particularly preferred if the decrease in the spacing of the flanks of the thread pitch is restricted to the region of a decreasing external diameter of the outer thread.

Here, a particularly favourable decrease is obtained in the spacing of the thread flanks when said spacing decreases per revolution by 0.1% to 2%, preferably by 1%.

Alternatively, a reduction in the screw-in torque during tapping can also be achieved in that the angle of the flanks of the thread pitch decreases from the end of the screw to the head of the screw.

In this respect, it is particularly preferred when the decrease in the angle of the flanks of the thread pitch is restricted to the region of a decreasing external diameter of the outer thread.

It has proved to be particularly advantageous when the angle of the flanks of the thread pitch decreases per revolution by 0.1° to 1°, preferably by 0.5°.

To further increase the pull-out strength of the screw, a relatively steep portion with a substantially small angle between the two flanks can be provided on the tip of each thread pitch.

In this respect, it is particularly preferred if the angle between the flanks of the relatively steep portion is only approximately half the size of the angle between the flanks in the near-core region of the thread pitch.

### BRIEF DESCRIPTION OF THE DRAWINGS

In the following, the present invention will be described in more detail with reference to the embodiment illustrated in the drawings, in which:

FIG. 1 is a side view of a self-tapping screw according to the invention having a conical screw-in region;

FIG. 2 shows the screw of FIG. 1, viewed from the head;

FIG. 3 is a sectional detail view from the side of the configuration of the thread of a screw according to the invention; and

FIG. 4 is also a sectional view from the side of the detail of an individual thread pitch of FIG. 3.

### BEST WAY TO IMPLEMENT THE INVENTION

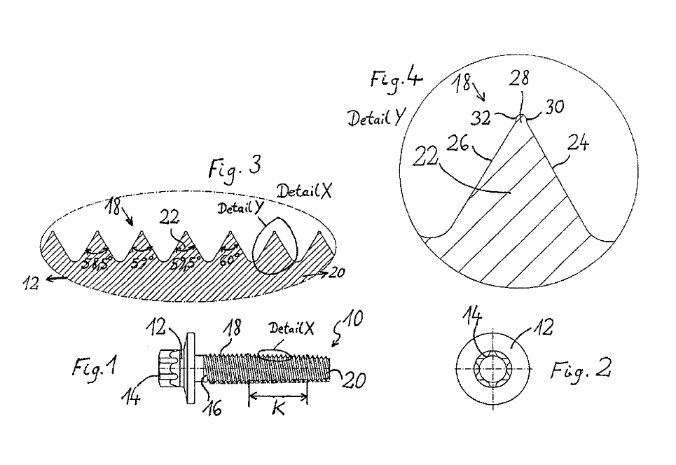

FIG. 1 shows a self-tapping screw 10 according to the invention from the side. The screw 10 comprises a conventional head 12 with an outer force application 14 and an outer thread carrier 16 with an outer thread 18. The outer thread carrier 18 has a conventional tapered end 20.

Here, however, the invention provides that a region K between the end 20 and approximately the centre of the outer thread 18 is not cylindrical as is otherwise customary for screws, but is slightly conical, this region running towards the end 20 at an angle of 1.2°, i.e. the external diameter of the outer thread carrier 16 decreases in this region towards the end 20. This conical region K preferably extends over the screw-in region.

This screw-in region preferably corresponds to the thread engagement.

FIG. 2 shows the screw of FIG. 1 viewed from the head.

FIG. 3 shows the detail X from FIG. 1. Here, the thread 18 according to the invention is shown in detail in a sectional view in the conical screw-in region K along a plane through the rotational axis of the outer thread carrier 16.

The individual cut thread pitches 22 are shown in detail here. The detail also extends like FIG. 1, i.e. the end 20 of the screw 10 is arranged on the right-hand side while the head 12 would be positioned on the left.

As shown in FIG. 3, the screw 10 according to the invention has in the conical screw-in region K thread pitches 22 which become narrower or slimmer as the external diameter of the outer thread 18 increases. For this purpose, in the illustrated embodiment, the angle between the two flanks 24, 26 of the thread pitch 22 decreases from revolution to revolution. This figure shows the decrease from 60° through 59.5° for the thread pitch closest to the head side, to 59° and finally to 58.5°. In the same way, the angle between the two flanks 24, 26 decreases further by 0.5° in each case per revolution towards the head. The corresponding decrease ends and the thread pitches then have a width which remains constant or a flank angle which remains constant as soon as the sloping region K ends and merges into the conventional cylindrical screw thread. To further increase the pullout resistance of the illustrated self-tapping screw 10 according to the invention, the thread pitches 22 illustrated here are not provided on their outer end with a rounded or angular tip, but they merge into a narrower and steeper nose 28, as shown in greater detail in FIG. 4.

This nose 28 then has between its two flanks 30 and 32 an angle which corresponds to only half the angle between the flanks 24 and 26.

The advantage of the invention described above is seen in the feasibility of an unchanging flank engagement in conically moulded holes and when required, by the additional flank prominence 28 in the achievement of a further increase in the pull-out strength.

The self-tapping screw according to the invention makes it possible to implement screw-in depths of any size, so that it is also possible to use this screw in very highly stressed applications which have hitherto been unsuitable for the self-tapping screws of the prior art due to their unsatisfactory performance. An example of this would be the cylinder head screw connection in engines.

According to the invention, a self-tapping screw which is otherwise always formed cylindrically is adapted in the angular path of its outer thread to the shape of the moulded hole and thus an optimum engagement of the thread is achieved in moulded holes which are inevitably always conical.

1-12. (canceled)

13. Self-tapping screw having a head and an outer thread carrier with an end, wherein the outer thread has an external diameter which decreases towards the end at least over a part of its length adjoining the end and wherein the spacing of the thread flanks of the thread pitch decreases from the end of the screw to the head of the screw.

14. Self-tapping screw according to claim 13, wherein the external diameter of the outer thread decreases according to the draft angle of the holes into which the screw is to be introduced.

15. Self-tapping screw according to claim 13, wherein the external diameter of the outer thread decreases such that a line which joins the tips of the thread pitches of the outer thread runs towards the end at an angle of 1.0° to 2.0°, preferably at 1.2° towards the rotational axis of the outer thread.

16. Self-tapping screw according to claim 13, wherein the region of a decreasing external diameter extends approximately over the entire screw-in depth (thread engagement).

17. Self-tapping screw according to claim 13, wherein the decrease in the spacing of the thread flanks of the thread pitch is restricted to the region of a decreasing external diameter of the outer thread.

18. Self-tapping screw according to claim 13, wherein the spacing of the thread flanks per revolution decreases by 0.1% to 2%, preferably by 1%.

19. Self-tapping screw according to claim 13, wherein the decrease in the angle between the thread flanks of the thread pitch is restricted to the region of a decreasing external diameter of the outer thread.

20. Self-tapping screw according to claim 13, wherein the angle between the thread flanks of the thread pitch decreases by 0.1° to 1°, preferably by 0.5° per revolution.

21. Self-tapping screw according to claim 13, wherein a relatively steep portion having a substantially smaller angle between the two flanks is positioned on the tip of each thread pitch.

22. Self-tapping screw according to claim 21, wherein the angle between the flanks of the relatively steep portion is only approximately half the size of the angle between the flanks in the near-core region of the thread pitch.
